(19) United States
(12) Patent Application Publication
(10) Pub. No.: US 2008/0177418 A1
(43) Pub. Date: Jul. 24, 2008

(54) Order-Picking System and Method Using RFID

(76) Inventor: Gerhard Schaefer, Neunkirchen (DE)

Correspondence Address: KEVIN J. MCNEELY, ESQ., 5335 WISCONSON AVENUE, NW, SUITE 440, WASHINGTON, DC, 20015, US

(21) Appl. No.: 11/834,610

(22) Filed: Aug. 6, 2007

Related U.S. Application Data
(63) Continuation of application No. PCT/EP2006/000571, filed on Feb. 18, 2005.

(30) Foreign Application Priority Data
Feb. 18, 2005 (AT) A 272/2005 AT

(51) Int. Cl. G06F 7/00; G06F 19/00

(52) U.S. Cl. 700/215; 340/572.1

(57) ABSTRACT

The invention relates to a method and a system for order picking different types of goods and respectively different product batches, according to which the goods are respectively stacked in an unmixed manner in output devices, removed from the output devices according to a order-picking order, and transported to a output point. The goods are removed from the output device from one end of the stack, and supplied to the output device at the other end of the stack. According to the invention, in the event of a change in the production batch of the goods along the stack, the first product of the new production batch is provided with a signal emitter that co-operates with a reading device arranged along the transport path, between the output device and the output point. If the signal emitter is detected by means of the reading device, the corresponding order-picking order preferably is supplied to a checkpoint.

### RELATED APPLICATIONS

This is a continuation application of co-pending International Patent Application PCT/EP2006/000571 which claims priority of the Austrian Patent Application A 272/2005 AT filed on Feb. 18, 2005 which is fully incorporated by reference herewith.

### BACKGROUND OF THE INVENTION

The invention relates to a method for order picking goods of different kinds of goods and of respectively different production batches wherein the goods of only one sort or kind are respectively stored in output devices in a stacked manner, picked from the output devices in accordance with an order-picking order and conveyed to an output point, wherein the picking of the goods from the output device happens from one end of the stack, and the supply of goods to the output device happens to the respectively other end of the stack, in accordance with the preamble of claim 1.

The present invention further relates to an order-picking system for order-picking goods of different kinds of goods and respectively different production batches wherein the order-picking system is formed such that for each order-picking order batch information is retrievable.

### RELATED PRIOR ART

This kind of method wherein goods of different kinds of goods, at first, have to be delivered by only one sort from a production system or from a storage room, and to be put together within an order-picking system for forming order-picking orders including goods of different kinds of goods, are well known. At the same time the order-picking system uses output devices within which a specific kind of goods is stored respectively by only one sort, for example, in a stacked manner.

The goods of the specific kind of goods often belong to different production batches, wherein it can be sometimes relevant to which production batch the goods belong which are apart from that present by only one sort. One example thereof are, e.g., goods having a pull date or an expiry date such as medicine. When composing an order-picking order it now can be decisive not to mix up goods of the same kind of goods, but from different production batches, or to at least examine this order-picking order. Further, it can be desirable to know which customer was delivered with goods of which production batch. Therefore, however, order-picking orders containing goods from different production batches have to be detected, and, if necessary, selected from the remaining order-picking orders.

### SUMMARY OF THE INVENTION

Therefore, it is the goal of the invention to provide such a method according to which individual order-picking orders containing goods of different production batches can be tracked and, if necessary, selected, in order to carry out a corresponding post control or check. Additionally, this method should offer opportunities for automation. These goals are obtained by the features of claim 1.

Presently, claim 1 relates to a method for order-picking goods of different kinds of goods and respectively different production batches, wherein the goods are stored by only one sort in output devices in a stacked manner, are picked from the output devices in accordance with an order-picking order, and are conveyed to an output point, wherein the picking of the goods from the output device occurs from one end of the stack and the supply of goods to the output device from the respective other end of the stack. In accordance with the invention, it lies within the framework of such a kind of method, that upon changing of the production batch of the goods along the stack the first good of the new production batch is provided with a signaler interacting with a reading device being arranged along the conveyor path between the output device and the output point, wherein upon detection of the signal by the reading device the corresponding order-picking order is supplied to a checkpoint. Due to storage in a stacked manner within the output device goods of the relevant kind of goods are picked orderly always from the relevant production batch. However, if all goods of this production batch are used up, change of the production batch will take place, from a last piece of good of that production batch to the first piece of good of a new production batch. An order-picking order including such goods of that kind of goods, for which a change of the production batch has been performed, thus will contain that piece of good which was marked by the signaler. If a corresponding reading device is arranged on the conveyor path between the output device and the output point, hence exactly that order-picking order can be identified and supplied to a subsequent check.

Thus, an order-picking order is present at the checkpoint containing goods of the same kind of goods but from different production batches. Now, for facilitating the identification of the goods to be checked, the features of claim 2 can be provided according to which the goods are provided with a kind code for identifying the kind of goods before the supply to the respective output device, and the signaler is assigned to a kind code by an electronic administration system, wherein upon detection of the signaler the corresponding kind code is determined by the administration system and provided to the checkpoint. Thus, at the checkpoint it is known which kind of good is to be checked, facilitating the check significantly.

Further, it is advantageous if already at the time of supplying of new goods of a kind of good to an output device it is apparent whether goods of a new production batch are supplied. Preferably, this should happen automatically. As a result, claim 3 provides that the goods are provided additionally with a batch code for identifying the production batch before being supplied to the respective output device, wherein the electronic administration system compares upon the supply of new goods to the respective output device the batch code of the goods to be supplied with ones of goods which are already present in the output device, and signals the presence of different production batches. If the supply of new goods to the output device happens automatically, the corresponding batch code can be transmitted automatically to the administration system, and the presence of different production batches can be registered within the administration system or also signaled, for example, by means of a message to the corresponding output device. If the supply of new goods to the output device happens manually, then the provision of the batch code, e.g. via radio or via a data connection of another kind, can be performed also by an operator who subsequently also receives the signal on the presence of different production batches.

The features of claim 3 also allow another advantageous embodiment as proposed in claim 4. Claim 4 provides that upon detection of the signaler the corresponding kind code as well as the corresponding batch code is determined by the administration system and provided to the checkpoint. Thus, not only information on the kind of goods, for which a mix-up of different production batches is given, is present at the checkpoint but also on the different production batches per se.

Even further, it can be advantageous to make the output device identifiable by a code hereinafter being designated as automaton code. Claim 5 provides that each of the output devices is provided with an automaton code, wherein the electronic administration system performs an assignment between the automaton code and the kind code of the kind of goods being stored in the relevant output device. Since merely genuine goods are deposited in the output device, also a specific kind of goods is identified by the automaton code.

An advantageous usage of an embodiment according to claim 5 is proposed in claim 6. Claim 6 provides that upon supply of new goods to the output device and upon picking of goods from this output device the corresponding number of pieces is transmitted to the electronic administration system, wherein the falling below a minimum number of goods in this output device is signaled including an information on the corresponding automaton code. Thus, the approaching emptying of the output device, and thus of a required supply of new goods of the corresponding kind of goods, can easily be determined. The signaling can, for example in completely automised systems, be exploited for correspondingly driving supply means, or serve for notifying an operator when filling happens manually. Since the automaton code is transmitted, the operator can easily identify the output device to be filled.

Sometimes it is advantageous or even necessary to store these goods at first in storage shelvings of the order-picking system, when the goods are delivered from the production system or a storage room to the order-picking system, before being taken in order to fill the output devices. In those cases, claim 7 provides that the goods are stored in storage shelvings before being supplied to the output device, wherein the storage shelving is respectively provided with a shelving code, wherein the electronic administration system performs an assignment between the shelving code as well as the kind code and batch code of the goods stored within the relevant storage shelving. Thus, it is exactly registered in the administration system, which goods of a specific kind of goods originate from which production batch and in which storage shelving they are stored.

This proves particularly advantageous in such cases, when the output devices now have to be filled with goods which have been deposited in storage shelvings. According to claim 8 it is now provided that upon the supply of new goods from a storage shelving to an output device the corresponding shelving and automaton code is transmitted to the electronic administration system, which determines the kind and batch code from the shelving code, and from the automaton code the batch code of the goods already present in the output device, and signals the presence of different production batches.

According to claim 9, a RFID transponder can be used as the signaler. According to claims 10, 11, 12, and 13 it is proposed to respectively use a bar code label or a numeric code derived therefrom as kind code, batch code, automaton code, or shelving code.

Additionally, according to the present invention an order-picking system for order picking goods of different kind of goods and respectively different production batches is provided, wherein the system comprises: at least one output device, in which the goods can be stored in a stacked manner in order to be picked from one end of the stack for order-picking purposes and to be supplied for refilling at another

end of the stack; a transponder attached to a predetermined good of a respective production batch and carrying an information associated with the production batch; and a reading device for detecting the transponder.

Thus, the system of the invention allows goods of different production batches to be tracked and, if necessary, selected. A warehouse administration system superordinated to the order-picking system being implemented on a warehouse administration host such as a host or PC, coordinates the order picking of goods or articles according to order-picking orders. When ejecting a good being provided with the transponder, i.e. upon a change of batch, the transponder leaves the output device together with the good and typically is supplied to an order container. The reading device reads the information contained within the transponder and provides that to the warehouse administration system. Thus, particularly later, it is always possible to re-enact from which production batch which article gets into a specific order-picking order.

Preferably, the order-picking system further comprises a conveyor technique, particularly a collecting belt, onto which the output device outputs goods to be order picked, wherein the conveyor technique goes past the reading device such that the transponder and the reading device can, particularly electromagnetically, interact with each other.

In this way it can always be ensured that a transponder is reliably detected when passing the reading device. Due to the fixed arrangement of the conveyor technique and the reading device with respect to each other, it is nearly excluded that the transponder passes the reading device in an area, in which the reading device cannot detect the transponder.

According to a preferred embodiment, the transponder is a passive transponder.

Passive transponders are characterized in that they do not include its own energy supply. Therefore, the transponder is smaller. A smaller frame size is particularly of interest if the number of a specific type of goods within an order-picking shaft is determined by means of a distance measurement of the upper end of the order-picking shaft relative to the good which is located at the upper end of the stack of goods.

Another advantage is to be seen in that the transponder can always be reused in the order-picking system. For this purpose, the transponders are taken from the flow of goods after being detected, particularly before the goods are given into the order container. Besides that, it has turned out as an advantage if the transponder includes two directional antennas which are arranged relatively to each other such that they substantially emit perpendicularly to each other.

Two directional antennas orientated perpendicular to each other increase the likelihood of the reading device for actually receiving a signal from the transponder. Particularly, in medicine-wholesale trade great amounts of different medicines, representing the goods, are retrieved per order-picking order. Thus, it can happen that the transponder, if all goods of an order-picking order are collected, is covered by one or more goods. This is particularly problematic if so-called blister packages having metal films are used. The metal films act as insulators at electro-magnetic radiation.

Since the two antennas have main radiation directions being perpendicular to each other, thus the likelihood is increased that the reading device receives at least the signals of one of the directional antennas.

Preferably, the directional antennas respectively comprise a core of ferrite.

The core of ferrite amplifies the magnetic component of the electromagnetic radiation such that the likelihood of signal detection is significantly increased.

According to another embodiment, the transponder is integrated into a support structure which particularly is made of plastic. The geometry of the support structure is adapted to the geometry of the good to be order picked in at least such areas in which a contact between the support structure and the good to be order picked occurs.

In this manner it is ensured that the transponder can be attached loosely on the good to be marked. This allows sorting out the transponder after detection has happened. The transponder can be released from the good without damaging the good.

Another advantage is present if the support structure has an L-shaped section and is attached to the good releasably so that the good and the support structure separate from each other automatically after output from the output device has happened.

An ashlar is an often used shape of good. Particularly medicines or pharmaceuticals are packed in ashlar-shaped packages. If the support structure corresponds to a substantially perpendicular angular, thus it can be orientated readily along an edge of the package and safely connect thereto in a loose manner. Particularly, if several medicines are stacked in one order-picking shaft, the support structure can be secured to the first good of a production batch.

Another advantage is provided if the output device is a picking automat, particularly an A-frame, a Multitec, a K-Pemat, etc. having at least one shaft of goods.

A picking automat can readily be operated in an automated manner by an superordinated warehouse administration system. Thus, the entire method or the system can be operated automated. The picking automates “Multitec” and “K-Pemat” are manufactured by the SSI Schafer Peem company, Graz, Austria.

According to another preferred embodiment, at the lower end of the shaft of goods a separation device for automated outputting individual goods is provided.

The separation device in the form of an ejection automation increases the automation degree further and assists also the ejection of the transponder.

Even further, it is preferred if the reading device has two antennas which are opposingly arranged to each other.

Particularly, both of the antennas are arranged above and beneath the conveyor track. In this way it is ensured that the signals transmitted by the transponder are detected by at least one antenna with a great likelihood. Thus, it is almost impossible that a transponder passes through the area of the reading device without being detected.

According to another preferred embodiment the conveyor track is constructed in several parts, and electrical insulators are provided between some of the parts.

Thereby closed electrical circuits are avoided being capable of disturbing the antennas of the reading device by means of induction. Thus, it is ensured that the antennas detect the transponder signals undisturbed in any case.

It will be appreciated that the above-mentioned and following features to be explained are not only usable in the respective given combination but also in other combinations or alone without leaving the frame work of the present invention.

### BRIEF DESCRIPTION OF THE DRAWINGS

Exemplary embodiments of the invention are depicted in the figure and will be explained more detailed in the following description.

FIG. 1 shows a schematic representation of a possible embodiment of an order-picking system for performing the method of the present invention, as viewed from above,

FIG. 2 shows a schematic representation of the front view of an output device,

FIG. 3 shows a flow diagram for summarizing method steps concerning the delivery of goods to the order-picking system,

FIG. 4 shows a flow diagram for summarizing method steps concerning the re-filling of the output device,

FIG. 5 shows a flow diagram for summarizing method steps concerning the compilation and checking of order-picking orders,

FIG. 6 shows an schematic perspective view of an angled formed transponder according to the present invention,

FIG. 7 shows a side view of a front side of an order-picking automat according to the present invention, and

FIG. 8 shows a schematic perspective view on a reading device which is used with the order-picking system of the present invention.

### DESCRIPTION OF PREFERRED EMBODIMENTS

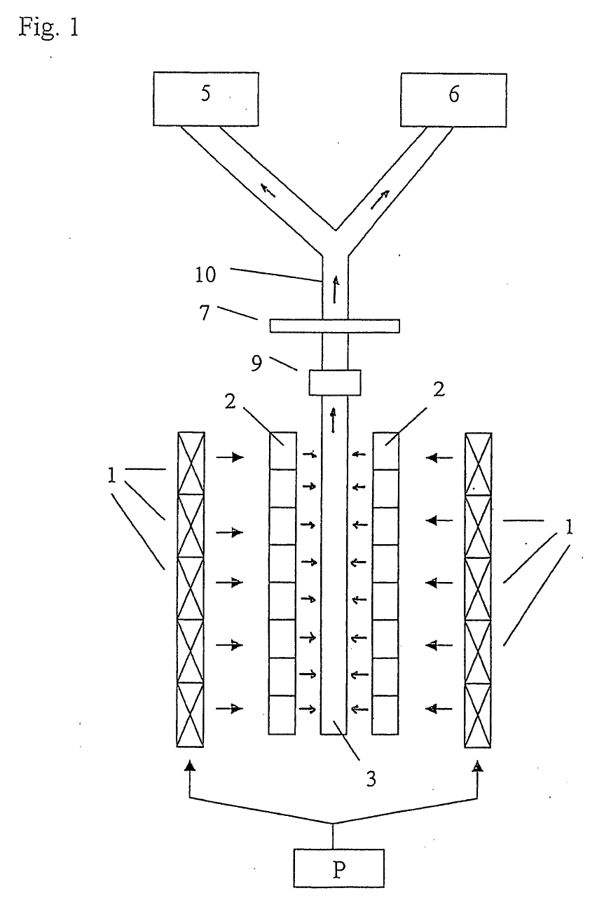

FIG. 1 depicts a schematic representation of one possible embodiment of an order-picking system for performing the method of the present invention. It is to be noted that the embodiment of the order-picking system can vary, also with respect to the distribution of automated and manual method sequences. Wares or goods 4 are provided from a production system or a store room P to the order-picking system. The goods 4 of one single kind are delivered, but can originate from different production batches. The kind of goods 4 are respectively marked with a kind code such as an article number. But the article number, as a general rule, does not distinguish between goods of different production batches. That is why for each good 4 also a batch code is given which provides information on the fact from which production charge the goods originate. Article number and batch number can be marked on the goods 4, for example, by means of a bar code label. In the following the terms “kind code” and “batch code” mean both the physical bar code label as well as the number coded therewith. For example, if a good 4 is to be provided with a “kind code”, thus both is meant the attaching of, for example, a bar code label as well as the assignment to a corresponding numeric code. “Transmission”, for example, of the kind code, for example, to an electronic administration system means that the numeric code is transmitted but, of course not the physical bar code label.

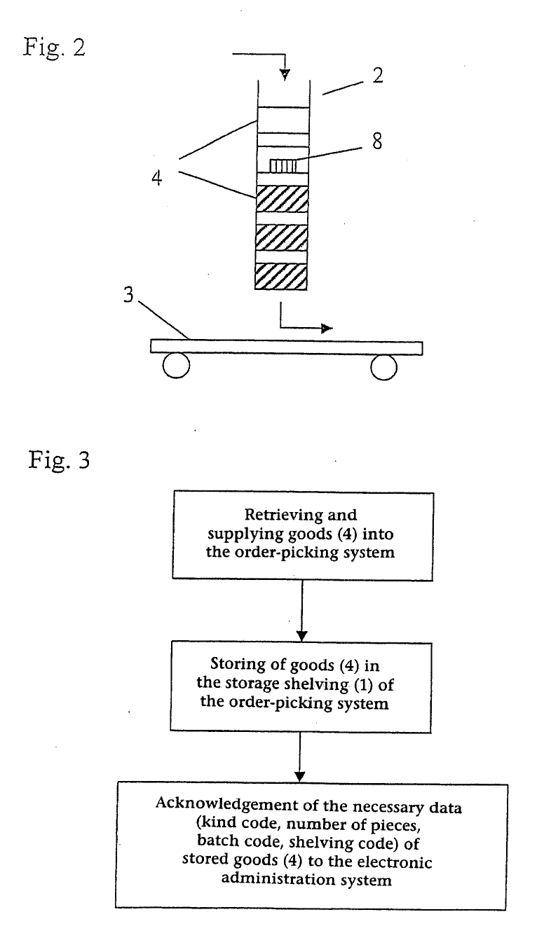

The goods 4 are distributed to different storage shelvings 1, wherein the storage shelvings 1 are provided with a shelving code, for example in terms of a bar code label. In the electronic administration system, which, for example, is realized by means of corresponding software on a computer and which, if necessary, is also provided with control and regulation functions, the article number and batch number are commonly stored with the corresponding shelving code. Consequently, it is exactly determined which good 4 from a kind of goods and from a specific production batch is in which storage place within the storage shelving 1. The bar codes can be read by an operator, for example, scanned in, and sent to an administration system by means of, for example, a radio terminal, wherein the bar codes can be evaluated and the evaluation results can be sent back to the operator. That delivery process is also illustrated in FIG. 3.

The output devices 2 can be supplied with goods 4 from the storage shelving 1, either manually or automated. In the following a manually filling of the output devices 2 with the goods 4 is assumed. Within the output devices 2, which are also designated “picking automates” (for example so-called “A-frames” have been used in the pharmaceutical industry), the goods 4 are stored in a shaft on top of each other in a stacked manner. A schematic representation of such an output device 2 is exemplarily depicted in FIG. 2. The respectively lowest arranged article 4 is supplied by an automatic ejection device of a conveying means 3 such as a conveyor belt. The control of the ejection device happens through the administration system in which also the individual order-picking orders, i.e. a specific constellation of predetermined number of goods of different kind of goods, are recorded. Preferably, also each output device 2 is associated with a code allowing the identification of a specific output device which, hereinafter, will be designated automaton code. Also this code can be provided by means of a bar code.

When supplying new goods 4 to the output device 2 and when picking goods 4 from that output device 2 the corresponding numbers of pieces are transmitted to the electronic administration system, wherein the falling below a minimum number of goods 4 within that output device 2 is signaled together with an indication of the corresponding automaton code. Thus, an approaching emptying of an output device 2, and consequently a necessary supply of new goods 4 of the corresponding kind of goods, can be determined easily. In this case of manually filling of the output device 2 the operator is notified. Since the automaton code is transmitted, the operator can easily identify the output device 2 to be filled.

By scanning the corresponding automaton code, the article 4 to be refilled is indicated to the operator. After the reading-in of the corresponding shelving code of that storage shelving 1 associated with the article 4, the electronic administration system of the operator also compares the present production batch within the storage shelving 1 to the one in the output device 2. If the production batches are different, then this will be notified to the operator. In this case, the first article 4 of the new production batch will be provided with a signaler 8 and put on the articles 4 of the preceding production batch in the output device 2.

The signaler 8 can be, for example, an RFID (radio frequency identification) transponder. Transponders consist of a computer chip having a processor and an operating system as well as a transmitter and receiver having an antenna for reading out the chip contactlessly. This gives rise to distinguish between passive transponders and active transponders, wherein the later is equipped with a current supply (battery). If an RFID reading device emits a radio signal, then the passive transponder answers by sending the data stored therein to the reading device. In the following it is assumed that a passive transponder is used as the signaler 8.

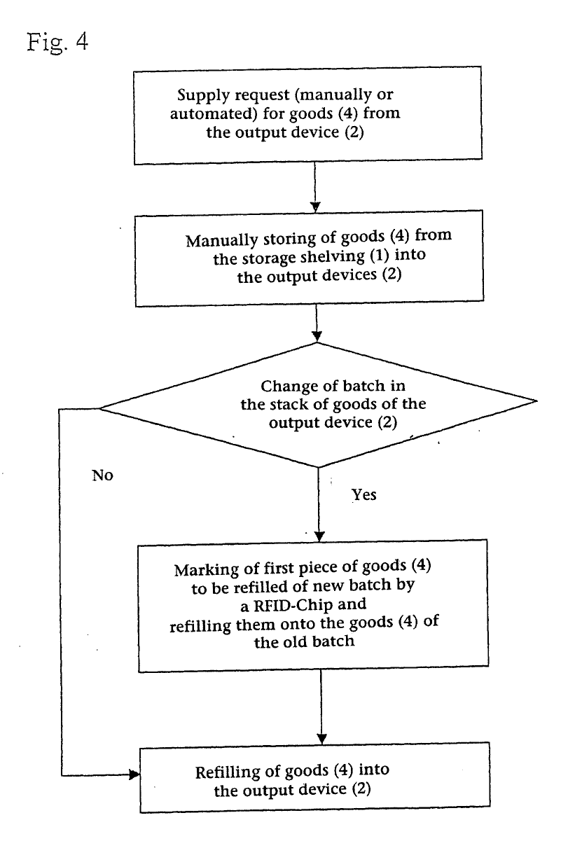

Also, the signaler 8 can be provided with a bar code. By scanning the bar code label on the RFID transponder 8 and the automaton code, the output device 2 and transponder 8 are data-technically associated with each other. Then, the shaft of the output device 2 is filled with the goods 4 of the new production batch so that a configuration as depicted in FIG. 2 is achieved. The goods 4 of the preceding production batch are marked with a hatching in FIG. 2, and the goods 4 of the new production batch lying on top thereof are depicted without hatching. Marking the remaining goods by an RFID transponder is not required. These method steps are summarized also in FIG. 4.

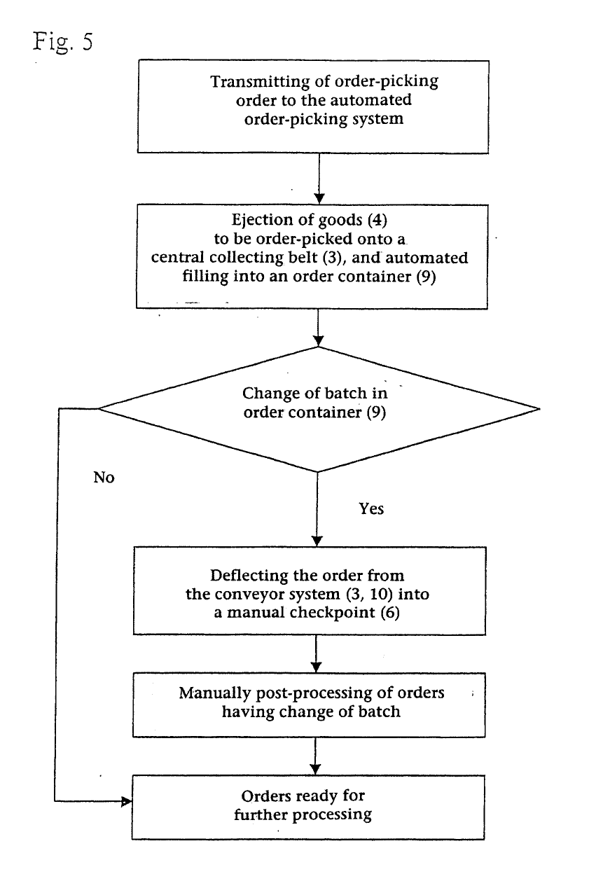

The selected goods 4 of an order-picking order are collected in an order container 9 being transported by means of a conveying means 10. The order container 9 passes subsequently a reading device 7 which detects the presence of a signaler 8 within the order container 9, and thus an executed change of production batch of a kind of goods. Therefore, it is known that all further goods 4 of that kind of goods belong to a new production batch, and thus all order-picking orders, which are configured after that order-picking order and which contain goods 4 of that kind of goods are to be assigned to the new production batch. If several goods 4 of the corresponding kind of goods are in that order container 9, then this order container 9 can be supplied to a checkpoint 6 where another check or processing can be formed since it is not guaranteed whether that order-picking order exclusively contains goods 4 from a single production batch or a mixture of different production batches. These method steps are also summarized in FIG. 5.

Preferably, the administration system determines upon detection of the signaler 8 the corresponding kind code as well as the corresponding batch code and provides that to the checkpoint 6. Thus, the checkpoint 6 not only has information on the kind of goods, where a mixture of different production batches is given, but also on the different production batches per se.

If the reading device 7 does not detect the presence of a signaler 8, then the corresponding order-picking container 9 is supplied to the output point 5.

Thus, the method of the present invention allows individual order-picking orders, which contain goods of different production batches, to be tracked, and, if necessary, selected in order to examine them in a corresponding post control. That method additionally provides possibilities for automation as far as possible, as explained above.

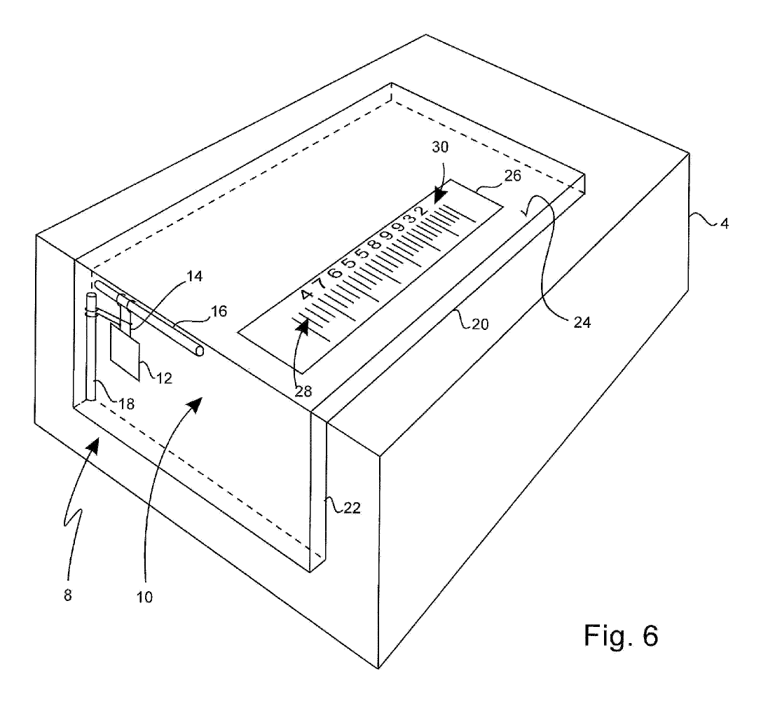

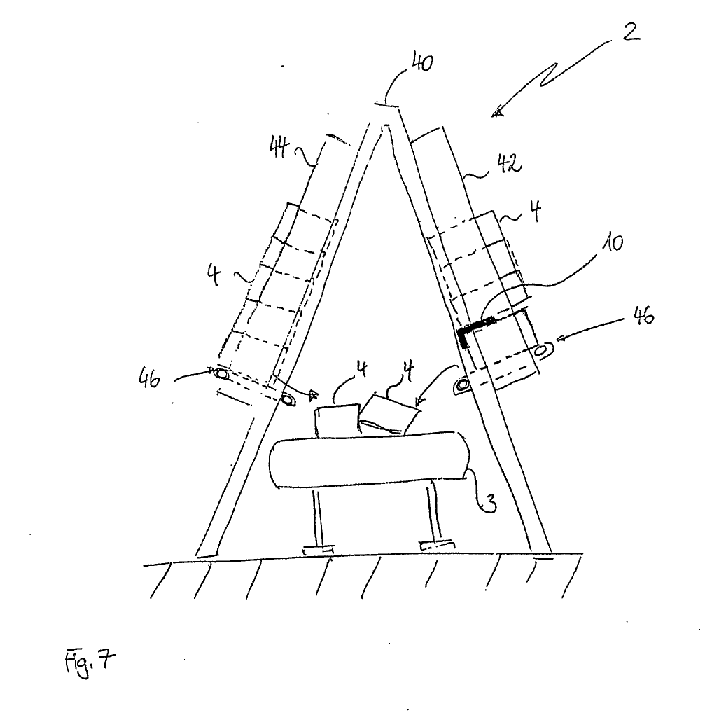

FIG. 6 shows a strongly schematized representation of a signaler 8, which includes a support structure 10. The signaler 8 further comprises a chip 12 which serves, among other things, for storing the batch information. The chip 12 is part of a transponder and additionally comprises terminals 14. The terminals 14 are connected to coil windings surrounding two cores 16 and 18 of ferrite.

The two cores 16 and 18 of ferrite serve as beam antennas. Further it would be possible to provide a third antenna which is perpendicularly orientated relative to the two cores 18 and 18 of ferrite. The antennas can arbitrarily be orientated with respect to each other. However, it is preferred if they substantially emit into the three spatial directions.

The support structure 10 is substantially formed in the shape of an L. The longer leg of the L is designated by 20 in FIG. 6. The shorter leg is designated by 22. On the upper face 24 of the leg 20 a label 26 can be attached optionally, the label being capable of carrying a bar code 28 and/or a numeric code 30.

Preferably, the antenna 16 and 18 are orientated along the edges, forming the part 22, within the legs 22. In FIG. 6 the leg 22 is depicted transparently as indicated by the dashed line. As a general rule, the angled support structure 10 is made of plastic into which the transponder is molded.

Further, it is clear that the geometrical shape of the support structure 10 is preferably adapted to the shape of the good 4.

The good 4 being depicted in FIG. 6 has an ashlar-like shape. Therefore, an angle is preferably used as the support structure 10 which fits tightly to the sides of the good 4. But the shape of the support structure can be varied in dependence on the shape of the good 4.

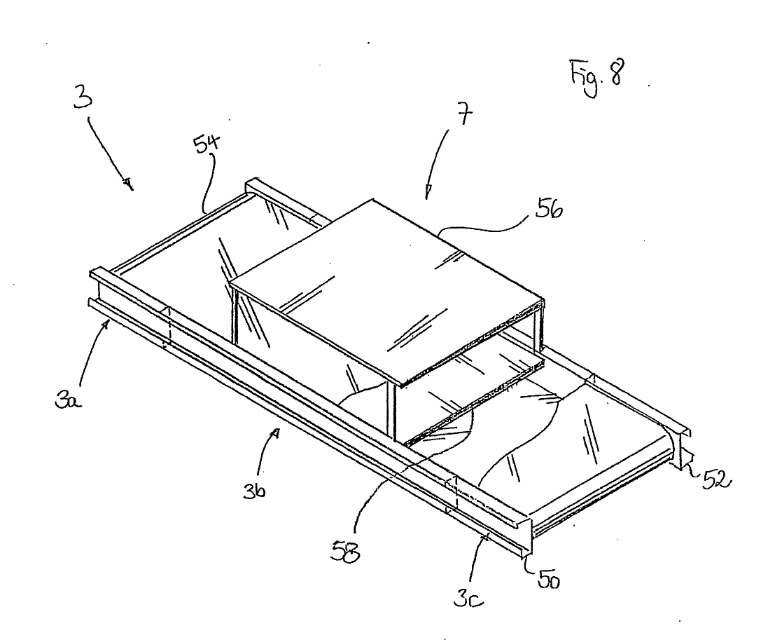

In FIG. 7 a front view of the output device 2 is schematically depicted as it is exemplarily shown in FIG. 1. The output device 2 is a order-picking automate of the type “A-frame”. An A-frame comprises an A-shaped frame 40. An order-picking shaft 42 and 44, respectively, is mounted to the two external legs of the frame 40. Goods 4 can be stored in terms of stacks within the order-picking shaft 42. At the lower end of the order-picking shafts 42 and 44, respectively, an ejection device 46 for ejecting articles 4 being stored in the shaft onto the centrally arranged conveyor track 3 is provided. The conveyor track 3 is a conveyor belt 3. In the order-picking system shown in FIG. 7 the collecting belt 3 is moved out of the drawing plane.

A good 4 is illustrated on the right hand side showing the order-picking shaft 42 of FIG. 7 at a lower end of the stack, the good carrying on its upper face (loosely) a support structure 10 including a transponder. This good 4 is the first article of a production batch. All further goods, which are arranged above that first good 4 having the support structure 10, belong to the same production batch.

It is clear that the assigning between a support structure 10 and a batch can be achieved differently. For example, the last article of a batch can be provided with the support structure 10 such that the warehouse administration system upon detection of that support structure 10 obtains a signal according to which articles of a different batch are picked. Thus, it is possible that the lower most article within the order-picking shaft 42 is the last article of a first production batch. The article before the lower most article would then be the first article of a second production batch. This would be advantageous in that a order-picking person (not illustrated) would have to put the support structure 10, when filling the shaft 42 with a new batch of articles, merely on the upper most article.

FIG. 8 shows a schematic perspective view of a reading device 7.

The reading device 7 is arranged in direct proximity relative to the conveyor track 3. In FIG. 8 the conveyor track 3, in turn, is realized by a collecting belt 3. The collecting belt has lateral strips 50 and 52 which preferably have T-shaped sections. The dimension shown in FIG. 8 does not correspond to reality. For the sake of illustration, the longitudinal length of the collecting belt 3 is illustrated in a strongly shortened manner.

The collecting belt 3 can be formed of several parts, particularly in the area of the reading device 7, as indicated by dashed lines in the area of the strips. The arrangement consisting of several parts serves for avoiding closed electrical conductor circuits which might effect the functionality of the reading device 7. Without the division into several parts the lateral strips 50 and 52 would form together with the deflection rollers, which are not illustrated, an electric conductor loop in a horizontal plane.

Since the reading device 7 typically communicates with the transponders by the way of electromagnetic interaction, magnetic induction within that conductor loop could occur upon emission of a reading pulse by the reading device 7. Due to the interruption, which is particularly amplified by electric insulators, this magnetic induction can be put to a stop. In FIG. 8 three sections 3a, 3b, and 3c of the collecting belt 3 are exemplarily shown, wherein particularly within the area of the reading device 7 the electric insulation is of particular advantage.

The reading device 7 comprises in the example shown in FIG. 8 two flat antennas 56 and 58. However, other antennas could be used.

The antenna 56 preferably is arranged above the conveyor belt 54. The second antenna 58 particularly is arranged directly beneath the conveyor belt 54. For the sake of illustration, the upper part of the conveyor belt 54 is depicted sectional in a rear part of the reading device 7. The antennas can be arranged arbitrarily, for example, also laterally. Also, more than two antennas can be provided. The more antennas are used, the greater the magnetic field becomes by which the transponders are read. As a result, the reading quality is also increased.

The distance of the upper antenna 56 can be chosen variable and particularly depends on the range of the antenna. The distance should be selected such that articles 4 can be driven through the reading device 7 also if they are standing upright on the belt 54.

The reading device 7 is connected to the warehouse administration system, being not depicted in FIG. 8, via signal lines which are not depicted, such as the “Profibus”. If a transponder is moved through the reading device 7, the reading device 7 outputs a signal to the warehouse administration system. If necessary, the transponder can be sorted out from the stream of goods after detection occurred, in order to be reused in an A-frame.

By using two flat antennas 56 and 58 it is ensured that the transponder in any case is detected by the reading device 7 upon passage. Even if the transponder is buried beneath a mountain of articles, a relatively high likelihood exists that one of the beam antennas of the transponder communicates at least with one of the antennas 56 or 58.

Therefore, what we claim is:

1. A method for order-picking of goods of different kinds of goods and respectively different production batches wherein goods of one kind only are respectively stored in output devices in a stacked manner, picked from the output devices in accordance with an order-picking order and conveyed to an output point, wherein the goods are picked out of the output device from one end of the stack and respectively supplied to the output device to the other end of the stack, wherein a first good of a new production batch, when changing the production batch of goods along the stack, is provided with a signaler which cooperates with a reading device arranged along a conveyor path between the output device and the output point.

2. The method for order-picking of goods of claim 1, wherein the goods of this corresponding order-picking order are supplied to a checkpoint, when the signaler is detected by the reading device.

3. The method for order-picking of goods of claim 1, wherein the goods are provided with a kind code for identifying the kind of goods before the supplying of the goods to the respective output device, and the signaler is assigned the kind code by an electronic administration system, wherein the corresponding kind code is determined by the administration system and provided to the checkpoint, when the signaler is detected.

4. The method for order-picking of goods of claim 3, wherein the goods are additionally provided with a batch code for identifying the production batch before the supplying of the goods to the respective output device, the electronic administration system comparing the batch code of the goods to be supplied with those goods being already present in the output device during the supply of new goods to the respective output device, and signals the presence of different production batches.

5. The method for order-picking of goods of claim 4, wherein, upon detection of the signaler, the corresponding kind code as well as the corresponding batch code are determined by the electronic administration system and provided to the checkpoint.

6. The method of order-picking of goods of claim 3, wherein each of the output devices is provided with an automaton code, the electronic administration system performing an assignment between the automaton code and the kind code of the kind of goods being stored in the relevant output device.

7. The method for order-picking of goods of claim 6, wherein, during the supply of new goods to the output device and during the picking of the goods out of the output device, a corresponding number of pieces is transmitted to the electronic administration system, wherein falling below a minimum number of goods in this output device is signaled, and the corresponding automaton code is indicated.

8. The method for order-picking of goods of claim 4, wherein the goods, before being supplied to the output device, are stored in the storage shelving, each of the goods being provided with a shelving code, wherein the electronic administration system performs an assignment between the shelving code as well as the kind code and the batch code of the goods stored in the relevant storage shelving.

9. The method for order-picking of goods of claim 8, wherein the corresponding shelving code and automaton code, when new goods are supplied from a storage shelving to an output device, are transmitted to the electronic administration system, which determines the kind code and batch code from the shelving code and determines from the automaton code the batch code of the goods already existing in the output device, and signals the presence of different production batches.

10. The method for order-picking of goods of claim 1, wherein an RFID-transponder is used as the signaler.

11. The method for order-picking of goods of claim 3, wherein a bar code label, or a numeric code derived therefrom, is used as the kind code.

12. The method for order-picking of goods of claim 4, wherein a bar code label, or a numeric code derived therefrom, is used as the batch code.

13. The method for order-picking of goods of claim 6, wherein a bar code label, or a numeric code derived therefrom, is used as the automaton code.

14. The method for order-picking of goods of claim 8, wherein a bar code label, or a numeric code derived therefrom, is used as the shelving code.

15. An order-picking system for order-picking of goods of different kinds of goods and of respectively different production batches, comprising:
at least one output device in which goods of one kind only can be stored in a stacked manner in order to be picked from one end of the stack and to be supplied for refilling at the other end of the stack;
a transponder attached to a specific good of a production batch and carrying information associated with the production batch; and
a reading device for detecting the information of the transponder.

16. The order-picking system of claim 15, wherein a conveyor track is further provided onto which the output device gives goods to be order picked, wherein the conveyor track is guided along the reading device such that the transponder and the reading device interact with each other.

17. The order-Picking system of claim 16, wherein the conveyor track is a collecting belt.

18. The order-picking system of claim 15, wherein the transponder is a passive transponder.

19. The order-picking system of claim 18, wherein the transponder includes two beam antennas arranged relatively to each other such that signals can be emitted at least into two spatial dimensions.

20. The order-picking system of claim 19, wherein the beam antennas respectively include a core of ferrite surrounded by at least one coil winding.

21. The order-picking system of claim 18, wherein the transponder is integrated into a support structure, a geometry of which is at least partially adapted to a geometry of the good to be order picked.

22. The order-picking system of claim 20, wherein the support structure comprises an L-shaped section and further is attached releasably to the good such that the good and the support structure separate independently from each other after being output by the output device.

23. The order-picking system of claim 15, wherein the output device is an order-picking automate having at least one shaft of goods.

24. Order-picking system of claim 23, wherein a separating device for ejecting individual goods in an automated manner is provided at a lower end of the shaft of goods.

25. The order-picking system of claim 15, wherein the reading device includes two antennas being arranged relative to each other in an opposing manner.

26. The order-picking system of claim 16, wherein one of the antennas is arranged above the conveyor track and the other antenna is arranged beneath the conveyor track.

27. The order-picking system of claim 26, wherein the conveyor track is constructed in several parts, and electric insulators are provided between some of the parts in order to avoid a closed electric circuit in the area of the antennas.
